(19) United States
(12) Patent Application Publication
(10) Pub. No.: US 2026/0267707 A1
(43) Pub. Date: Sep. 10, 2026

(54) DEVICE COOPERATION WHEN PERFORMING A TASK

(71) Applicant: Telefonaktiebolaget LM Ericsson (publ), Stockholm (SE)

(72) Inventors: Saeed BASTANI, Lund (SE); Farnaz MORADI, Stockholm (SE); Tommy ARNGREN, Luleå (SE); Richard Bin XIAO, Stockholm (SE); Vandita SINGH, Stockholm (SE)

(73) Assignee: Telefonaktiebolaget LM Ericsson (publ), Stockholm (SE)

(21) Appl. No.: 19/151,033

(22) PCT Filed: Jan. 26, 2023
(86) PCT No.: PCT/EP2023/051935

§ 371 Date: Jul. 25, 2025

(51) Int. Cl. G06F 9/50; G06F 9/48; G06N 3/045; G06N 3/092

(52) U.S. Cl. CPC G06F 9/505; G06F 9/4893; G06N 3/045; G06N 3/092

(57) ABSTRACT

Methods, devices and computer programs are disclosed. The disclosure provides a method performed by a device, wherein the device is associated with a pool of resources, and wherein the device is communicatively coupled to a remote device. The method comprising the steps of obtaining a computing task, the task being associated with at least one performance requirement to be satisfied when performing the task; determining, from the pool of resources, local resources suitable to complete the task; determining, based on the at least one performance requirement and the determined local resources, whether to perform the computing task locally or to offload the computing task to a remote device; when the device determines to offload the computing task, endowing the remote device with a portion of the pool of resources in exchange for offloading the computing task.

### TECHNICAL FIELD

The disclosure relates to methods, devices, and computer programs. More particularly, but non-exclusively, the disclosure relates to task offloading and resource sharing between devices.

### BACKGROUND

Electronic devices, such as consumer electronics or wearables, may have different types and amounts of device resources, such as processing, memory, hardware, battery, available to them for performing various tasks.

For example, sensors between devices, and even in the same device, can differ in many ways, such as in the type of modality, e.g., vision vs. audio sensors, in different operation principles across the same modality, i.e., infrared (IR) camera vs red, green, and blue (RGB) camera, and in different capabilities, e.g., 4K resolution vs. high definition (HD) in RGB camera, to mention a few.

Given a certain computing task that requires sensing and processing, one or more sensors in one or multiple devices might be needed to cooperatively sense and process information to perform the task. However, not all sensors need to be used together in all scenarios. For example, some sensors could inform others about the need to process data.

The “cooperation” here covers two separate scenarios, one relating to a single device, another one to multiple devices. A single device with different sensor types may rely on so-called “sensor fusion” or “data fusion”, where the sensors cooperate to resolve one task using multimodal information.

Multiple devices with the same sensor type rely on “session aggregation” or “data aggregation” where the information from different sensors can complete or complement each other by providing more information to complete the task.

In an example multi-device scenario, a client device has an inertial measurement unit (IMU) and a camera sensor, which can operate in different resolutions, but the client device does not have a simultaneous localization and mapping (SLAM) algorithm (or at least not an efficient SLAM algorithm and/or hardware) to map and localize itself in the environment, or client device has the needed algorithms but does not have access to the environment map, which could be expensive and time consuming to create. On the other hand, two other devices are equipped with SLAM algorithms and have pre-mapped the environment. The two other devices could differ in many ways, for example in the type of SLAM algorithm available or in the quality of environment map held at each device. For example, first of the other devices might have a conventional SLAM algorithm whereas the second of the other devices is equipped with a deep learning SLAM, each with different accuracies and latencies of execution. Another example is that the first device can only support sparse SLAM while the second device can support dense SLAM.

### SUMMARY

When the client device wants to localize itself in the environment, it may be either not feasible or very costly or the device may not achieve a desired accuracy etc. The device also pays a cost, which can manifest in a used-up resource, such as energy, for sensing and processing. In most scenarios, the resources available to the devices are not infinite and there is a need to properly balance the costs and workload when multiple devices are cooperating, to minimize some devices being overutilized when others are underutilized, consider dynamic changes in resource availability and cost of use, and provide ways for effective cooperation when devices belong to different entities.

The object of the present invention is therefore to provide a solution to at least some of the above problems.

The device pays a cost, which can manifest in a used-up resource, such as energy, for sensing and processing. At the same time, the device may harvest resources, e.g., energy from other devices in return, or receive payoffs in other forms such as communication bandwidth endowed by other devices in the form of traffic relaying, for instance.

In a cooperative scenario, the devices need to solve a problem of optimally balancing their cost, e.g., energy used, and payoffs, e.g., energy received, while satisfying Key Performance Indicators (KPIs) required for a given task. In an example scenario of robot navigation in an environment, such KPIs may comprise accuracy and latency. The goal is to leverage diversity in terms of sensing and device processing capabilities for efficient use of resources while satisfying desired KPIs.

In accordance with a first aspect of the present invention, there is provided a method performed by a device, wherein the device is associated with a pool of resources, and wherein the device is communicatively coupled to a remote device. The method comprises the steps of obtaining a computing task, the task being associated with at least one performance requirement to be satisfied when performing the task. The method further comprises determining, from the pool of resources, local resources suitable to complete the task. The method further comprises determining, based on the at least one performance requirement and the determined local resources, whether to perform the computing task locally or to offload the computing task to a remote device. When the device determines to offload the computing task, the device then endows the remote device with a portion of the pool of resources in exchange for offloading the computing task.

In accordance with a second aspect of the present invention, there is provided a computer program comprising instructions which, when executed on at least one processor, cause the device to carry out a method according to the first aspect.

In accordance with a third aspect of the present invention, there is provided a device associated with a pool of resources, wherein the device is communicatively coupled to a remote device, the device being configured to obtain a computing task, the task being associated with at least one performance requirement to be satisfied when performing the task. The device is further configured to determine, from the pool of resources, local resources suitable to complete the task. The device is further configured to determine, based on the at least one performance requirement and the determined local resources, whether to perform the computing task locally or to offload the computing task to a remote device. When the device determines to offload the computing task, the device is configured to endow the remote device with a portion of the pool of resources in exchange for offloading the computing task.

In accordance with a fourth aspect of the present invention, there is provided a device associated with a pool of resources, wherein the device is communicatively coupled to a remote device, the device comprising a processing circuitry and a memory storing instructions which, when executed by the processing circuitry, cause the device to obtain a computing task, the task being associated with at least one performance requirement to be satisfied when performing the task. The device is further caused to determine, from the pool of resources, local resources suitable to complete the task. The device is further caused to determine, based on the at least one performance requirement and the determined local resources, whether to perform the computing task locally or to offload the computing task to a remote device. When the device determines to offload the computing task, the device is further caused to endow the remote device with a portion of the pool of resources in exchange for offloading the computing task.

In accordance with a fifth aspect of the present invention, there is provided a device associated with a pool of resources, wherein the device is communicatively coupled to a remote device, the device comprising an obtaining unit for obtaining a computing task, the task being associated with at least one performance requirement to be satisfied when performing the task. The device further comprises a first determining unit for determining, from the pool of resources, local resources suitable to complete the task. The device further comprises a second determining unit for determining, based on the at least one performance requirement and the determined local resources, whether to perform the computing task locally or to offload the computing task to a remote device. The device further comprises an endowing unit for, when the device determines to offload the computing task, endowing the remote device with a portion of the pool of resources in exchange for offloading the computing task.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a schematic of an example of cooperation between devices.

FIG. 2 is a flow chart of a method performed by a device according to some embodiments.

FIG. 3 is a diagram illustrating a general principle of reinforcement learning.

FIG. 4 is a sequence diagram illustrating an example of cooperation between a device and a remote device.

FIG. 5 is block diagram of a device according to some embodiments.

FIG. 6 is a block diagram of device according to some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general-purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor, DSP hardware, a reduced instruction set processor, hardware (e.g., digital or analogue) circuitry including but not limited to application specific integrated circuit(s), ASIC and/or field programmable gate array(s), FPGA(s), and (where appropriate) state machines capable of performing such functions.

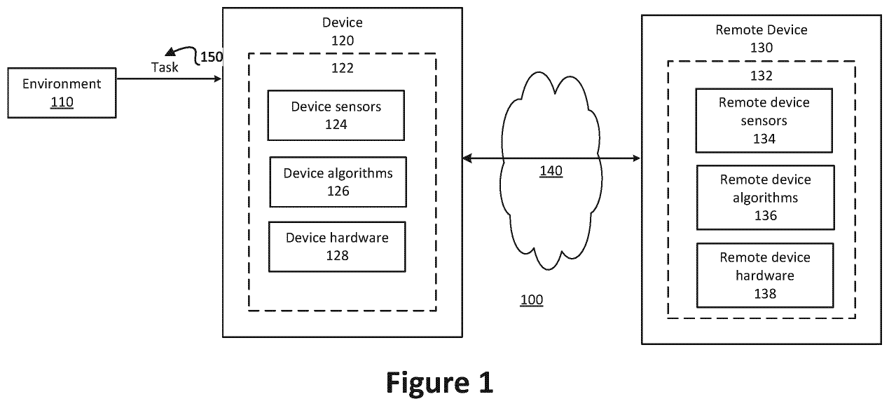

FIG. 1 illustrates an example of a cooperation 100 between devices 120, 130 when performing a task 150. The device 120 may cooperate with multiple remote devices (figure shows one remote device 130 only for ease of illustration). At least one or more embodiments advantageously introduces incentive mechanisms for enabling cooperating devices to perform complex tasks, such as sensing and perception of the environment. Incentive plays a key role for enabling device cooperation, specifically when the devices belong to different users or entities. The notion of energy harvesting strongly incentivizes battery-powered devices to seek cooperation with other devices. Also, energy harvesting is an advancing technology and could proliferate as a technology available in many devices in future. Incentive-based cooperation provides for improved and more efficient use of limited resources. It also provides adaptability and flexibility in response to dynamically changing conditions in the environment, changing status of the devices etc.

A task 150 may be a computing task to be performed by one or more devices 120, 130. The task 150 may need processing of input data to generate a result or output. The task 150 may comprise one or more sub-tasks. The task 150 may be simple and computationally inexpensive, such as regularly sensing a temperature using a temperature sensor. The task 150 may be complex and resource intensive, for example object detection and tracking, or sensing of the surrounding environment and providing safe and efficient navigation to a robot.

The device 120 may receive the task 150 from an environment 110. The environment 110 may comprise another entity, for example another device, network node, that creates the task 150 and sends it to the device 120. The environment 110 may also comprise a user creating the task 150 and providing it to the device 120, e.g., via appropriate configuration via user interface. The environment 110 may also comprise a communication network or may correspond to an autonomous decision taken by the device 120 itself.

The task 150 is further associated with one or more performance requirements to be satisfied when performing the task 150. The performance requirement may comprise for example latency, accuracy. In one example, the latency requirement may comprise a maximum latency value when performing the task 150. In another example, the accuracy requirement may specify a minimum accuracy level for the task 150. In one example, when the task 150 is to train a machine learning model, the accuracy requirement may specify a desired level of accuracy of the trained model when performing the task 150, such as classification or detection of objects.

The device 120 is associated with a pool of resources. The pool of resources may comprise resources 122 local to the device 120 and resources remote to the device 120. Local resources may comprise resources available at the device 120 itself, for example software resources such as device algorithms 126, and hardware resources, such as device sensors 124 and device hardware 128. The pool of resources may be utilised by the device 120, e.g., to perform the task 150. Local resources 122 may comprise various sensors 124, depending on the type of the device 120. For example, a communications device, such as user equipment (UE), may comprise a camera, microphone, accelerometer, gyroscope etc. A robot may comprise a radar, camera, etc. The skilled person will appreciate that sensors 124 may also include software sensors.

Software resources may comprise algorithms or computer programs suitable for performing certain activity, such as visual object detection. There may be several algorithms available for performing certain task. Each of them may be associated with different resource usage, cost, efficiency, or accuracy.

Hardware resources may comprise hardware components such as central processing unit (CPU), graphical processing unit (GPU), random access memory (RAM), specialized hardware accelerators etc.

The resources remote to the device 120 may comprise any resource to which the device 120 may have a transferrable right to use or which may be indirectly used or controlled by the device 120 via an intermediary, such as a management node, gateway, etc. For example, the remote resources may comprise a bandwidth of a shared communication channel between the network local to the devices 120 and 130 and another external network.

The device 120 is communicatively coupled to one or more remote devices 130. In one example, the device 120 may be connected with the remote device 130 via a communications network 140, such as wired or wireless, local, Internet etc. The device 120 and remote device 130 may exchange data via the network 140.

The remote device 130 may be the device of the same or different type to the device 120. In one example, the remote device 130 comprises corresponding local resources 132, such as sensors 134, algorithms 136 and hardware 138 as with the device 120.

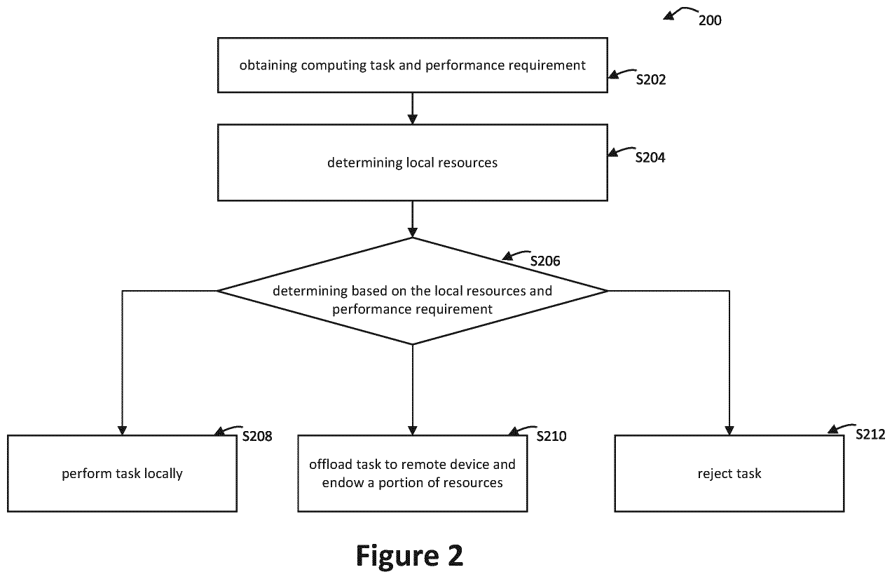

FIG. 2 illustrates a method 200 performed by a device 120 according to an embodiment. At step S202, the device 120 obtains a computing task 150, the task 150 being associated with at least one performance requirement to be satisfied when performing the task 150. At step S204, the device 120 determines, from the pool of resources, local resources 122 suitable to complete the task 150. The determined local resources may comprise one or more combinations of a software resource and a hardware resource of the device. For example, for performing an object detection task, the device 120 may have the following algorithms 126 available: a non-machine learning, a small neural network, and a large neural network. In terms of sensors 124, there may be a high-definition (HD) camera or low-resolution compact camera available. In case of hardware 128, there may be a choice of CPU, GPU, or a dedicated artificial intelligence (AI) accelerator. In one scenario, the outcome of this step may be a list L with a number of records R, where each record r represents a combination of an algorithm, a sensor s and hardware h, that is suitable to complete the task. Each record r may be extended with additional information, such as availability information representing availability (e.g., busy, free) of the resource for performing the task.

At step S206, the device 120 determines, based on the at least one performance requirement and the determined local resources, whether to perform the computing task locally or to offload the computing task 150 to a remote device 130. The device 120 may decide which combination of algorithm, sensor and hardware is best for performing the task when considering the at least one performance requirement. For example, when there is a requirement of low latency, but there is no requirement of used up energy or computational power, then for the object detection task the device 120 may select a combination comprising a small neural network and GPU, which will provide the object detection results faster than selecting a large neural network. There may be multiple decision variables when choosing the best combination which makes the selection of the best combination an optimization problem.

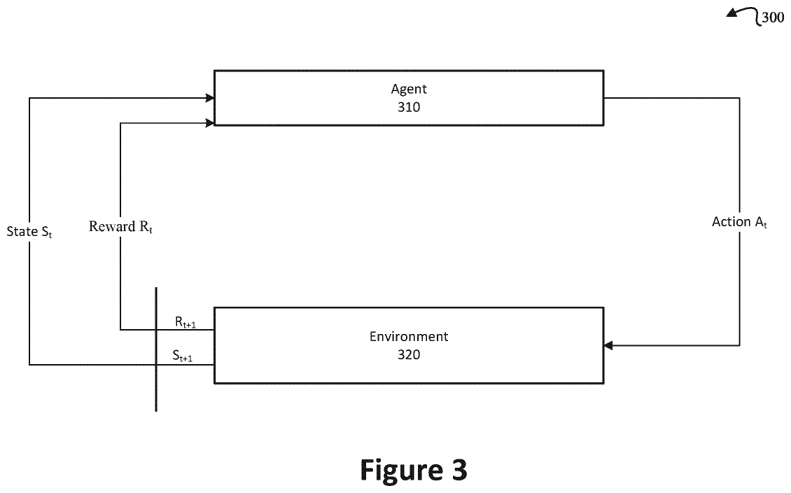

The step S206 may be further performed using a reinforcement learning (RL) agent. According to a general principle of reinforcement learning illustrated in FIG. 3, an agent 310 evaluates a reward for taking an action from a set of actions. The agent 310 takes an action Aₜ on the environment 320 at time t. The environment 320 then changes its state Sₜ and produces a reward Rₜ for taking the action Aₜ. The cycle then repeats at a next time instant t+1, with another action Aₜ₊₁ taken by the agent 310, producing a state Sₜ₊₁ and reward Rₜ₊₁.

In the context of the agent operating according to an embodiment, reinforcement learning advantageously allows one or more devices 120, 130 to learn how to adaptively share their resources among each other. This, in turn, allows devices 120, 130 to adapt to new settings where new types of resources are subject to sharing or new types of transferrable utilities (not limited to energy harvesting) emerge as incentives for cooperation. For example, each device 120, 130 may comprise an RL agent operating in the interest of respective device. Autonomous resource sharing enables scenarios for device cooperation where devices do not belong to a single user or authority, and where such users or entities have different preferences to cooperate with other users. For example, manufacturers may want their devices to offer some forms of cooperation, but each entity may have different preferences over processing sharing and energy harvesting.

The set of actions may comprise performing the computing task 150 locally and offloading the computing task 150 to the remote device 130, respectively. The reward may be calculated based on a performance requirement satisfaction reward representing a degree of fulfilment of the at least one performance requirement. For example, the task 150 may be associated with a KPI requirement of latency below a particular latency threshold. If the task is performed with overall latency not exceeding the latency threshold, then 100% of the reward may be achieved (e.g., an integer 100). If the achieved overall latency only gets to 50% of the latency threshold, then the reward may be 50% (e.g., an integer 50), and so on.

The reward may be further calculated based on a resource usage reward that is based on the determined local resources of the pool of resources required to complete the task 150. The resource usage reward may comprise an energy reward that is based on a first amount of energy needed to perform the action from the set of actions. For example, certain combinations of algorithms, sensors and hardware may be more costly in terms of energy than others. The use of a combination of a large neural network, CPU and HD camera to perform object detection task may typically consume more energy, such as battery power of the device 120, than a combination of small neural network, GPU, and low-definition camera. The lower the usage of energy to perform the task 150 using a certain combination of resources, the higher the resource usage reward.

The portion of the pool of resources may further comprise a second amount of energy, and when the device 120 determines to offload the computing task 150, the energy reward is based on the second amount of energy the device 120 endows the remote device 130 with. In an example, when the decision to offload the task 150 from the device 120 to the remote device 130 is associated with endowment of a portion of energy from the device 120 to the remote device 130, then the energy reward for the device 120 is negatively impacted proportionately to the portion of energy endowed to the remote device 130. Correspondingly, the energy reward for the remote device 130 is positively impacted proportionately to the portion of energy received as part of endowment.

In another example, the energy reward may further be based on a third amount of energy required to communicate the computing task 150 to the remote device 130. Transferring the task 150 between devices 120, 130 is associated with cost, such as transmission cost involving a cost of bandwidth and computing cost associated with sending and receiving at communication endpoints. The costs taken by respective device correspond to negative reward for said device.

The set of actions may further comprise a rejection of the computing task 150 by the device when the first amount of energy needed to perform the action from the set of actions is greater than a minimum battery level threshold. For battery-powered devices, it would be disadvantageous to allow the remaining battery energy to drop to 0, therefore the devices need to consider the minimum battery level threshold when deciding whether to perform the task locally. If any of the actions from the set of actions, such as performing the task 150 locally or offloading the task 150 are associated with energy cost that is greater than the minimum battery level threshold, then the decision is taken to reject the task 150.

In another example, the resource usage reward may comprise a communication bandwidth reward that is based on an amount of communication bandwidth needed to perform the action from the set of actions. For example, the devices may share bandwidth through relaying network traffic.

In another example, the at least one performance requirement may comprise a latency requirement and wherein the performance requirement satisfaction reward comprises a latency reward that is based on an amount of time needed to perform the action from the set of actions. For example, the latency requirement specified for the task may state that the latency should be below 100 ms. When the achieved latency when performing the task is below that threshold, for example 50 ms, then the latency reward may be 1, otherwise 0.

The latency reward may be further based on a local execution latency representing time required for the respective combination of the one or more of the software resource and hardware resource of the device to complete the task. For example, the same algorithm may experience different latency levels and consume different amount of energy on different hardware. Thus, different combinations of resources are associated with different expected latency levels when utilised to perform the task 150.

Offloading the computing task 150 may comprise transmitting the computing task 150 to the remote device 130 over a communication network 140. In such a case, the latency reward may be further based on an offloading latency comprising time required for the transmission of the computing task 150 to the remote device 130. The offloading latency may further comprise remote execution latency representing time required for respective combination of one or more of the software resource and hardware resource of the remote device 130 to complete the task 150.

The at least one performance requirement may comprise an accuracy requirement. The performance requirement satisfaction reward may comprise accuracy reward that is based on an accuracy of the computing task 150. In the example of object detection task, the associated KPI may specify that that the accuracy or confidence of detecting objects in the image must be above a certain threshold, e.g., 80%. The accuracy reward will then reflect a degree of fulfilment of this requirement. For instance, when the KPI is achieved, the reward will be 1, otherwise 0. The accuracy reward may further be based on a local execution accuracy representing accuracy achievable by the respective combination of the software resource and hardware resource of the device 120 when completing the task 150. The accuracy reward may further be based on an offloading accuracy representing accuracy achievable by respective combination of the one or more of the processing resource and hardware resource of the remote device 130 when completing the task 150.

Depending on the local resources and imposed performance requirements for the task 150, at step S208 the device 120 may decide that the task 150 may be performed locally by the device 120 using a selected combination of resources that optimizes the use of the resources. The device 120 may then proceed to initiate the resources in the selected combination and complete the task 150. For example, an image may be captured by the HD camera of the device 120 and fed to a large neural network for object detection. The neural network may utilise the GPU of the device 120 to generate a list of objects detected in the image.

In an alternative scenario, the device 120 may instead decide to offload the computing task 150 to a remote device 130 at step S210. For example, in the earlier step S206, the determination may indicate that there are no available local resources for performing the task 150 because all are busy performing something else, or that the ones available are too costly to use and/or they would result in breach of the imposed performance requirements. In such a case, it may be more efficient to offload the task 150 to the remote device 130 which, at that point in time, may have a better combination of resources available to complete the task 150 in accordance with performance requirements. Offloading the task may be implemented in several ways. For example, the device 120 may transmit the task data directly to the remote device 130 over the network 140. Alternatively, the network 140 may comprise a gateway or a management node, in which case the device 120 responds to the gateway or management node with a request for offloading the task 150 to the remote device 130. The gateway or management node then acts as an intermediary, forwarding the task to the remote device 130.

When the device 120 determines to offload the computing task 150, the device 120 endows the remote device 130 with a portion of the pool of resources in exchange for offloading the computing task 150. In this way, the cooperation between devices 120, 130 is based on incentive. As there is a cost (e.g., resource) for performing the task, there is an available payoff for compensating that cost. The portion of the pool of resources may comprise a portion of any endowable resource associated with the device 120. For example, the portion of resource may comprise an amount of energy. The remote device 130 may harvest an amount of energy directly from the device 120. Alternatively, the remote device 130 may harvest an amount of energy from another source, for example from a fixed energy distribution station or a base station. In one scenario, harvesting an amount of energy comprises harvesting energy from a radio frequency signal, such as a massive multiple input-multiple output, (MIMO) antenna in a wireless base station or access point. Devices 120, 130 may need to subscribe to an energy transfer service in the base station or access point beforehand. There may be other endowable resources used, such as a communication bandwidth which may be shared between devices 120, 130. An example of how energy harvesting may be performed is described in Y. Zhang, J.

He and S. Guo, “Energy-Efficient Dynamic Task Offloading for Energy Harvesting Mobile Cloud Computing,” 2018 IEEE International Conference on Networking, Architecture and Storage (NAS), 2018, pp. 1-4, doi: 10.1109/NAS.2018.8515736., where energy harvesting in the context of mobile edge cloud computing was proposed. The document teaches a mobile device that can perform radio frequency (RF)-based simultaneous wireless information and power transfer (SWIPT) from a base station.

Another result of the determination at step S206 may be the rejection of the task 150 by the device 120, to which the device 120 progresses at step S212. For example, when either performing the task 150 locally, or offloading the task 150 to the remote device 130 results in the energy costs at the device 120 beyond the available level of battery power or a reserved battery level threshold at the device 120, then the device 120 may decide to reject performing the task 150 entirely.

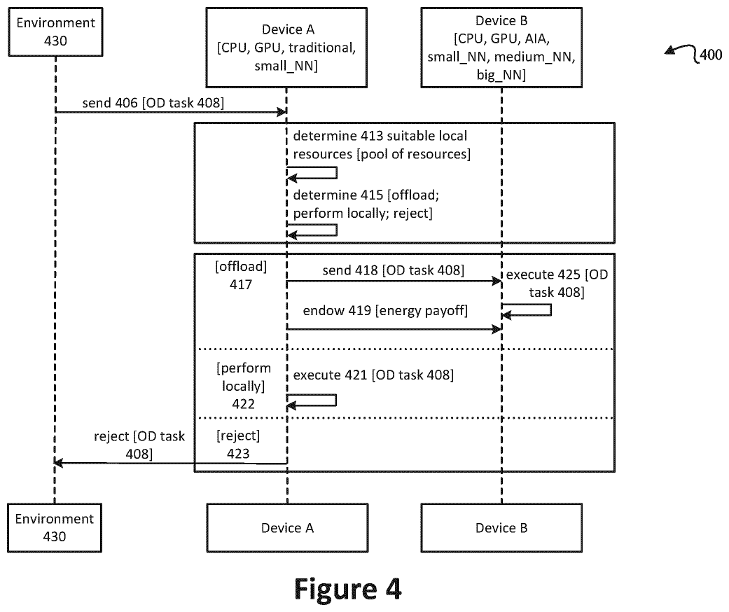

FIG. 4 illustrates some of the interaction in an example method 400 in a scenario involving object detection task 408 that is intended to identify a type and location of visual objects in a scene captured e.g., using a camera.

There exist many algorithms for object detection task 408 and each algorithm may be executed on different hardware. Different algorithms provide different accuracy levels but also different hardware resource demands, such as energy used. The same algorithm may experience different latency levels and consume different amount of energy on different hardware.

Device A, which may be a client device, may have two types of algorithms in its disposal to perform OD, a traditional, non-ML algorithm, and a small neural network (NN) algorithm. Denote algorithm set in A by G_{A}=<traditional, small_NN). Device B, which may be a serving device or remote device, on the other hand, has three neural network algorithms, a small NN, medium NN and a big NN. Denote the set of algorithms in B by G_{B}=<small_NN, medium_NN, big_NN). It is apparent that different algorithms provide different accuracy but also different demand for hardware resources.

Device A has two types of hardware for processing OD: H_{A}=<CPU, GPU>. Device B has an additional AI accelerator (AIA) for processing OD: H_{B}=<CPU, GPU, AIA>. Similar hardware types in A and B may have different performance, e.g., the GPU in A might be faster and low energy than the GPU in B.

Device A receives, at step 406, OD task 408, and determines, at step 413, suitable local resources to complete the task 408. The action space K_{A} of device A is the combination of algorithms and hardware resources in A if A decides to perform OD 408 locally, otherwise it may decide to offload 417 to device B or reject 423 the task 408, i.e. K_{A}={<traditional, CPU>, <traditional, GPU>, <small_NN, CPU>, <small_NN, GPU>, offload, reject_{A}}. The first four actions correspond to the decision of performing OD 408 locally in A, the fifth action correspond to action 417 of offloading OD 408 to B, which may comprise sending 418 the task over a network. The sixth action corresponds to rejecting 423 OD task 408 by device A. Similarly, the action space in B (denoted by KB) can be inferred from the combinations of its algorithms and hardware resources, plus action reject. Device B does not have offload action in this setting with only two devices A, B. But in a general case, when multiple devices are available, device B may have action offload which means the decision of offloading to another device other than A.

The latency L_{A} of performing OD 408 in A depends on which combination of algorithm and hardware is chosen, L_{A}={I_{A,<traditional,CPU>}, I_{A, <traditional, GPU>}, I_{A, <small_NN, CPU>}, I_{A, <small_NN, GPU>}, I_{A, offload}, I_{A, reject}}. Latency I_{A}, offload corresponds to the decision when the OD task 408 is offloaded 417 to B and includes latency for transmitting the data (RGB frame, for example) to B and the processing latency in B when the task 408 is executed 425. The used energy for performing OD 408 in A is E_{A}={e_{A, <traditional, CPU>}, e_{A, <traditional, GPU>}, e_{A, <small_NN, CPU>}, e_{A, <small_NN, GPU>>}, e_{A, offload}, e_{A, reject}}. Energy e_{A, offload} includes the amount of energy to transfer 418 data (e.g. RGB frame) and the amount of energy transferred 419 from A to B. If reject action 423 is chosen, then e_{A, reject}=0. The achieved accuracy of OD 408 in A is C_{A}={c_{A, <traditional, CPU>}, c_{A, <traditional, GPU>}, c_{A, <small_NN, CPU>}, c_{A, <small_NN, GPU>}, c_{A, offload}, c_{A, reject}}. Accuracy c_{A, offload} corresponds to the achievable accuracy of OD when performed in B, after selecting the best combination of algorithm-hardware which is to be learned using reinforcement learning agent in B. If reject action is chosen, then c_{A, reject}=0. Similarly, L_{B}, E_{B} and C_{B} represent the latency, used energy, and achieved accuracy if B choses to perform OD 408 using its own algorithms and hardware resources.

The state space of A and B are defined based on the availability of their hardware resources (denote by x) as well as the current battery level (in percentage, denote by b). Hence S_{A}=(<x_{A, CPU}, x_{A,GPU}>, b_{A}) and S_{B}=(<x_{B, CPU}, x_{B,GPU}, x_{B,AIA}>, b_{B}). X is a binary variable, x=1 means the resource is available and 0 means not available. Note that, in a general case, x can indicate the percentage of available or unutilized resource.

Device B preserves a minimum battery level b_{B, min}, and hence will reject performing OD 408 if the energy needed to perform OD 408 causes its battery level to fall below b_{B, min}, unless it can harvest 419 at least as much energy as it needs in a time threshold Tₕ to spend for performing OD 408. For example, device B, after selecting its best action, needs to spend e_{B,OD} to perform object detection task 408. If harvested energy eₕ in device B (from device A and other ambient RF sources) within a predefined time threshold Tₕ is e_{B, h}>=e_{B,OD}, device B may accept to process OD 408 depending on whether it can satisfy the accuracy threshold. Device A, as the client device, may or may not have such a preservation about its battery level, but if the energy needed to perform OD 408 locally in A is beyond its battery level, offloading 417 to device B also requires an energy e_{A, offload} (including energy to be transferred to B via harvesting (e_{A,B}) and energy needed to transfer data (e.g. RGB frame) from A to B, denoted by e_{A,tx}) is beyond available energy in A, then A may completely reject 423 performing A and may not offload 417 to B. There are many other scenarios that can arise in the interaction of A and B, and RL mechanism is intended to learn optimal decisions (i.e., actions) in each scenario.

Device A, as the client device, defines a minimum acceptable accuracy (C_{OD, min}) for OD 408. If neither A nor B, after choosing their best actions, learned via local RL agents in A and B, can meet C_{OD, min}, the task 408 is rejected 423, which leads to a minimum reward (e.g., zero) for both. If this requirement is too strong, it may be alleviated by setting C_{OD, min} in A in a way that, with a high probability, a device in a multi-device setting can be found that meets the accuracy threshold. For example, C_{OD, min} can be a learnable parameter. The exact method for setting C_{OD, min} is out of scope as is setting minimum acceptable latency L_{OD, min} predefined in A, which may be statically defined or learned.

The reward function in A and B may include KPI satisfaction reward and energy cost.

KPI satisfaction reward: depending on the actions taken by A and B and whether both C_{OD, min} and L_{OD, min} are satisfied or not when performing OD 408 locally in A or B, the possible scenarios and the corresponding rewards are:
If A rejects 423 the task 408, the accrued reward for KPI satisfaction by A and B are both zero (i.e. r_{A, KPI}=0 and r_{B, KPI}=0)
if A does not reject 423 and does not offload 417 the task 408 (offload=0 and reject_{A}=0), then if both C_{OD, min} and L_{OD, min} are satisfied by A, r_{A, KPI} is 1 for A, otherwise 0. The reward for B is r_{A, KPI}=0.
if A does not reject 423 but offload 417 OD task 408 to B (i.e., offload=1, reject_{A}=0), then if B does not reject (reject_{B}=0), and both C_{OD, min} and L_{OD, min} are satisfied by B, r_{B, KPI} and r_{A, KPI} are set to 1 for both A and B, otherwise if B rejects (reject_{B}=1) or if B cannot satisfy C_{OD, min} or L_{OD, min}, r_{A, KPI}=0 and r_{B, KPI}=0.

Energy cost:
if device A does not reject 423 the task 408 and choses to perform 422 OD 408 locally (offload=0 and reject_{A}=0), then the (normalized) energy reward for A is r_{A, e}=−e_{A}, */e_{A,b} where e_{A,*} is the energy consumed by applying 421 the best action among the local processing actions in A and e_{A,b} is remaining energy corresponding to current battery level in A. In this case the energy cost for B is r_{B, e}=0.
If device A does not reject 423 but choses to offload 417 the task 408 to B (offload=1 and reject_{A}=0), then if B does not reject the processing of OD (reject_{B}=0), the energy cost for B is r_{B, e}=min [(e_{A, B}−e_{B,*})/e_{B,b}), 1] where e_{B,*} is the energy consumed in B when performing 425 the best action among the local processing actions available to B, e_{A, B} is the energy harvested 419 from A in B, and e_{B,b} is the remaining energy corresponding to current battery level in B. In this case, the energy cost for A is r_{A, e}=max [−(e_{A, tx}+e_{A, B})/e_{A,b},−1], where e_{A, tx} is the energy used for data transmission 418 from A to B (e.g. transmitting an RGB frame as the input for OD algorithm) and e_{A, B} is the energy transferred 419 from A to B to compensate cost incurred to B. If device B choses to reject to perform OD task 408, then r_{B, e}=0 and r_{A, e}=max [−e_{A, tx}/e_{A,b}, −1] corresponding to a futile transmission 418 of data from A to B.

If the expected reward due to harvested energy by B (e_{A,B}) within time threshold Tₕ is e_{A,B}<e_{B,*}, where e_{B,*} is the energy used for OD 408 when applying best action selected by B, then B may choose to reject (reject_{B}=1). Also, if the energy for forwarding data plus transferring energy from A to B (denoted by e_{A, offload}) satisfies e_{A, offload}>e_{A,b}, where e_{A,b} is remaining energy corresponding to current battery level in A, then A chooses not to offload (Offload=0) the task 408 to B. The same applies to the energy for the transmission 418 of data from A to B even if B rejects the task but A should anyhow send the data due to lack of information about the decision in B; that is, if e_{A, tx}>e_{A,b}, then offload=0.

The reward functions r_{A}, r_{B} of devices A and B, respectively can be consolidated, addressing all the above scenarios as follows:

$${r}_{A} = {α}_{A} * {r}_{A , KPI} + {β}_{A} * {r}_{A , e}$$

$${r}_{B} = {α}_{B} * {r}_{B , KPI} + {β}_{B} * {r}_{B , e}$$

where α_{A} and β_{A} are predefined coefficients for KPI and energy rewards in device A. Similarly, α_{B} and β_{B} are predefined weights for KPI and energy rewards in device B. These coefficients can be fixed or adapted using machine learning techniques, for example. The exact way of adaptation of coefficients is out of scope of this invention. Reject_{A} is a binary variable which represents the action where device A rejects the OD task, and Rejects is the corresponding action chosen by device B. With the state space, action space and reward functions specified above for devices A and B, standard Q-learning mechanism, which is known from e.g., Watkins, Christopher J C H, and Peter Dayan. “Q-learning.” Machine learning 8.3 (1992): 279-292., can be applied separately in each device to learn the best policy, respectively.

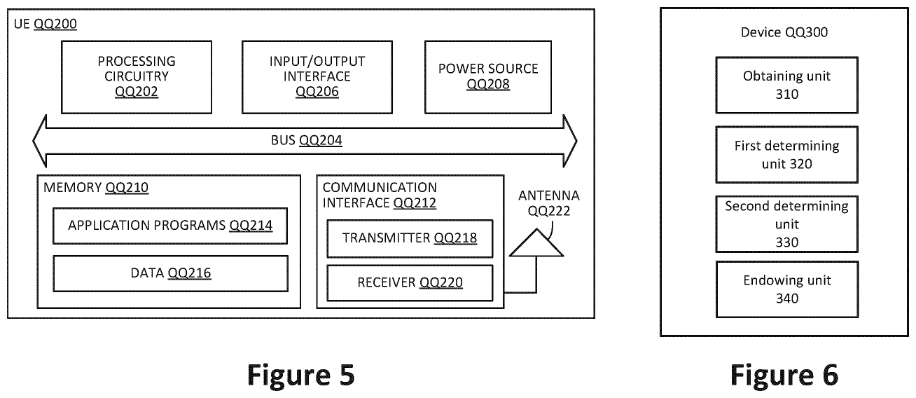

FIG. 5 is a block diagram illustrating a device QQ200 according to an embodiment. The device QQ200 is associated with a pool of resources, wherein the device QQ200 is communicatively coupled to a remote device 600. The device QQ200 illustrated in the figure may also be the remote device according to an embodiment. For example, the device and the remote device may have the same components, functions, algorithms, software, hardware, or may have a completely different setup and configuration. The device QQ200 may be an electronic device capable to communicate in a wired or wireless way with other devices. The device QQ200 may comprise a user equipment (UE). As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, sensors etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random-access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software, or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 5.

In yet another specific example, an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

The device QQ200 is configured to obtain a computing task, the task being associated with at least one performance requirement to be satisfied when performing the task. The device QQ200 is further configured to determine, from the pool of resources, local resources suitable to complete the task, and to determine, based on the at least one performance requirement and the determined local resources, whether to perform the computing task locally or to offload the computing task to a remote device. When the device QQ200 determines to offload the computing task, endowing the remote device with a portion of the pool of resources in exchange for offloading the computing task.

FIG. 6 illustrates a device QQ300 associated with a pool of resources, wherein the device is communicatively coupled to a remote device, the device comprising an obtaining unit 310 for obtaining a computing task, the task being associated with at least one performance requirement to be satisfied when performing the task. The device QQ300 further comprises a first determining unit 320 for determining, from the pool of resources, local resources suitable to complete the task, and a second determining unit 330 for determining, based on the at least one performance requirement and the determined local resources, whether to perform the computing task locally or to offload the computing task to a remote device. The device QQ300 further comprises an endowing unit 340 for, when the device determines to offload the computing task, endowing the remote device with a portion of the pool of resources in exchange for offloading the computing task.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method performed by a device, wherein the device is associated with a pool of resources, and wherein the device is communicatively coupled to a remote device, the method comprising the steps of:
obtaining a computing task, the task being associated with at least one performance requirement to be satisfied when performing the task;
determining, from the pool of resources, local resources suitable to complete the task;
determining, based on the at least one performance requirement and the determined local resources, whether to perform the computing task locally or to offload the computing task to a remote device;
when the device determines to offload the computing task, endowing the remote device with a portion of the pool of resources in exchange for offloading the computing task.

2. A method according to claim 1, wherein the determined local resources comprise one or more combinations of a software resource and a hardware resource of the device.

3. A method according to claim 2, wherein determining to perform the computing task locally comprises selecting a combination from the one or more combinations to complete the task.

4. A method according to claim 2, wherein the determined local resources further comprise availability data of the one or more of the software resource and hardware resource, respectively.

5. A method according to claim 1, wherein the determining whether to perform the computing task locally or to offload the computing task to a remote device is performed using a reinforcement learning agent that evaluates a reward for taking an action from a set of actions,
wherein the set of actions comprises performing the computing task locally and offloading the computing task to the remote device, respectively, and
wherein the reward is calculated based on a performance requirement satisfaction reward representing a degree of fulfilment of the at least one performance requirement, and a resource usage reward that is based on the determined local resources of the pool of resources required to complete the task.

6. A method according to claim 5, wherein the resource usage reward comprises an energy reward that is based on a first amount of energy needed to perform the action from the set of actions.

7. A method according to claim 6, wherein the portion of the pool of resources comprises a second amount of energy, and when the device determines to offload the computing task, the energy reward is based on the second amount of energy the device endows the remote device with.

8. A method according to claim 7, wherein the energy reward is further based on a third amount of energy required to communicate the computing task to the remote device.

9. A method according to claim 5, wherein the set of actions comprises a rejection of the computing task by the device when the first amount of energy needed to perform the action from the set of actions is greater than a minimum battery level threshold.

10. A method according to claim 5, wherein the resource usage reward comprises a communication bandwidth reward that is based on an amount of communication bandwidth needed to perform the action from the set of actions.

11. A method according to claim 5, wherein the determined local resources comprise one or more combinations of a software resource and a hardware resource of the device, and wherein the at least one performance requirement comprises a latency requirement and wherein the performance requirement satisfaction reward comprises a latency reward that is based on an amount of time needed to perform the action from the set of actions.

12. A method according to claim 11, wherein the latency reward is further based on a local execution latency representing time required for the respective combination of the one or more of the software resource and hardware resource of the device to complete the task.

13. A method according to claim 11, wherein offloading the computing task comprises transmitting the computing task to the remote device over a communication network, and wherein the latency reward is further based on an offloading latency comprising time required for the transmission of the computing task to the remote device.

14. A method according to claim 13, wherein the offloading latency further comprises remote execution latency representing time required for respective combination of one or more of the software resource and hardware resource of the remote device to complete the task.

15. A method according to claim 5, wherein the determined local resources comprise one or more combinations of a software resource and a hardware resource of the device, and wherein the at least one performance requirement comprises an accuracy requirement and wherein the performance requirement satisfaction reward comprises an accuracy reward that is based on an accuracy of the computing task.

16. A method according to claim 15, wherein the accuracy reward is further based on a local execution accuracy representing accuracy achievable by the respective combination of the software resource and hardware resource of the device when completing the task.

17. A method according to claim 15, wherein the accuracy reward is further based on an offloading accuracy representing accuracy achievable by respective combination of the one or more of the processing resource and hardware resource of the remote device when completing the task.

18. A method according to claim 1, wherein the endowing the remote device with a portion of the pool of resources comprises the remote device harvesting an amount of energy directly from the device.

19. A method according to claim 1, wherein the endowing the remote device with a portion of the pool of resources comprises the remote device harvesting an amount of energy from another source.

20. A method according to claim 18, wherein the harvesting an amount of energy comprises harvesting energy from a radio frequency signal.

21-27. (canceled)
